(19) United States
(12) Patent Application Publication
(10) Pub. No.: US 2013/0207892 A1
(43) Pub. Date: Aug. 15, 2013

(54) CONTROL METHOD AND APPARATUS OF ELECTRONIC DEVICE USING CONTROL DEVICE

(71) Applicant: Samsung Electronics Co., Ltd, (US)

(72) Inventors: Jae-Won Kim, Gyeonggi-do (KR); So-Young Kim, Seoul (KR); Woo-Hyoung Lee, Gyeonggi-do (KR)

(73) Assignee: Samsung Electronics Co., Ltd, Gyeonggi-do (KR)

(21) Appl. No.: 13/762,937

(22) Filed: Feb. 8, 2013

(30) Foreign Application Priority Data
Feb. 10, 2012 (KR) 10-2012-0013562

(51) Int. Cl. G06F 3/033

(52) U.S. Cl. CPC G06F 3/033
USPC 345/157

(57) ABSTRACT

A method and apparatus of controlling an electronic device use a control device. A method of the electronic device using the control device includes moving a cursor displayed on a screen of the electronic device according to cursor control information received from the control device, measuring a distance between a position of the cursor and a peripheral object, and, when the measured distance is less than or equal to a threshold distance, moving the cursor to a position corresponding to the peripheral object.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Feb. 10, 2012 and assigned Serial No. 10-2012-0013562, the contents of which are herein incorporated by reference.

### TECHNICAL FIELD OF THE INVENTION

The present disclosure relates to a control method and apparatus of an electronic device using a control device.

### BACKGROUND OF THE INVENTION

With the growth of electronic and communication technologies, the research and development of various devices providing a user convenience are made. Accordingly, smart TeleVisions (TVs) providing various contents services further to broadcasting functions of digital TVs are being provided and, together with this, various control devices for controlling the various contents services of the smart TVs are being provided. For example, in the past, a button type control device with a plurality of buttons was used for controlling a TV but, in recent years, a separate control device is being provided in which touch sense and screen display are possible. Also, recently provided is being a scheme of controlling the TV using a portable terminal of a user.

But, an operation of controlling the various contents services of the smart TVs by the control devices is configured complexly and difficulty for some classes of users such as the elderly, children, handicapped people and the like to manipulate, so the some classes of users are difficult to enough utilize various contents of the smart TVs.

### SUMMARY OF THE INVENTION

To address the above-discussed deficiencies of the prior art, it is a primary object is to provide a method and apparatus for controlling an electronic device using a control device.

Another aspect of the present disclosure is to provide a method and apparatus for controlling a cursor of a screen using motion information of a control device in an electronic device.

A further aspect of the present disclosure is to provide a method and apparatus for controlling an object list displayed on a screen using motion information of a control device in an electronic device.

Yet another aspect of the present disclosure is to provide a method and apparatus for controlling a movement of an object displayed on a screen using motion information of a control device in an electronic device.

Still another aspect of the present disclosure is to provide a method and apparatus for moving an object according to motion information of a control device, displaying the moved object, and executing a function corresponding to the movement of the object in an electronic device.

Still another aspect of the present disclosure is to provide a method and apparatus for controlling an object of an electronic device using motion information of a control device in the control device.

Still another aspect of the present disclosure is to provide a method and apparatus for providing a user interface controlling a screen of an electronic device in a control device.

The above aspects are achieved by providing a control method and apparatus of an electronic device using a control device.

According to one aspect of the present disclosure, a control method of an electronic device using a control device is provided. The method includes moving a cursor displayed on a screen of the electronic device according to cursor control information received from the control device, measuring a distance between a position of the cursor and a peripheral object, and, when the measured distance is less than or equal to a threshold distance, moving the cursor to a position corresponding to the peripheral object.

According to another aspect of the present disclosure, a control method of an electronic device using a control device is provided. The method includes moving a cursor displayed on a screen of the electronic device according to cursor control information received from the control device, checking if a movement direction of the cursor is equal to an object list direction, and, when the movement direction of the cursor is equal to the object list direction, moving an object list according to the movement direction of the cursor and displaying the moved object list.

According to a further another aspect of the present disclosure, a method for controlling an electronic device in a control device is provided. The method includes creating cursor control information using at least one sensor, transmitting the created cursor control information to the electronic device, and, when a screen touch by a user is sensed, transmitting a signal representing at least one of screen touch, touch and hold, and touch release, to the electronic device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system construction for controlling a screen of an electronic device according to an exemplary embodiment of the present disclosure;

FIG. 2 illustrates a block diagram of a construction of a portable terminal according to an exemplary embodiment of the present disclosure;

FIG. 3 illustrates a block diagram of a construction of a TeleVision (TV) according to an exemplary embodiment of the present disclosure;

FIG. 4 illustrates a process of a portable terminal according to an exemplary embodiment of the present disclosure;

FIGS. 5A to 5C illustrate a process of a TV according to an exemplary embodiment of the present disclosure;

FIGS. 6A to 6C illustrate a screen configuration of controlling a cursor in a TV according to an exemplary embodiment of the present disclosure;

FIGS. 7A and 7B illustrate a screen configuration of controlling an object list in a TV according to an exemplary embodiment of the present disclosure;

FIG. 8 illustrates a screen configuration of controlling an object list in a TV according to another exemplary embodiment of the present disclosure; and

FIGS. 9A and 9B illustrate a screen configuration of controlling object movement in a TV according to an exemplary embodiment of the present disclosure.

### DETAILED DESCRIPTION OF THE INVENTION

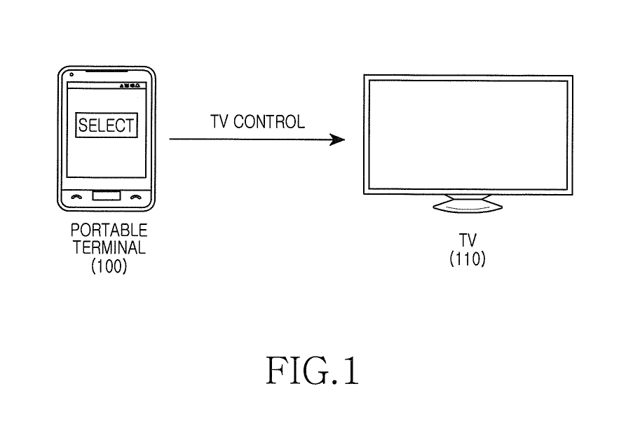

FIGS. 1 through 9B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Preferred embodiments of the present invention will be described herein below with reference to the accompanying drawings. In the following description, well-known functions or constructions are not described in detail since they would obscure the invention in unnecessary detail. And, terms described below, which are defined considering functions in the present invention, can be different depending on user and operator's intention or practice. Therefore, the terms should be defined on the basis of the disclosure throughout this specification.

A method and apparatus for controlling an electronic device using motion information of a control device according to the present disclosure are described below. Here, the electronic device is meaning including all of electronic devices in which screen display is possible and communication with an external device is possible, such as a digital TeleVision (TV), a smart TV, a portable terminal, a mobile phone, a mobile pad, a media player, a tablet computer, and a handheld computer. Also, the control device is meaning including all of electronic devices whose movement is easy according to user control, such as a portable terminal, a mobile phone, a mobile pad, a media player, a tablet computer, and a handheld computer. In the present disclosure, an embodiment where the electronic device is a TV and the control device is a portable terminal is described as an example for description convenience below.

FIG. 1 illustrates a system construction for controlling a screen of an electronic device according to an exemplary embodiment of the present disclosure.

Referring to FIG. 1, a portable terminal 100 transmits a control signal for controlling a cursor and object displayed on a screen of a TV 110 and various functions, to the TV 110. That is, the portable terminal 100 senses a motion of the portable terminal 100 dependent on a user control, and transmits the sensed motion information to the TV 110. Also, the portable terminal 100 senses a screen touch of a user of the TV 110, and transmits a signal representing selection or execution of a corresponding object, to the TV 110.

The TV 110 controls a cursor, an object, and various functions according to a control signal received from the portable terminal 100. That is, the TV 110 controls a movement of a cursor and object displayed on a screen of the TV 110 according to motion information received from the portable terminal 100, and controls a function for selecting or executing a corresponding object according to a selection or execution signal received from the portable terminal 100. Particularly, the TV 110 controls a cursor according to motion information received from the portable terminal 100, controls a function for moving the cursor to a specific object according to a distance between the cursor and an object and a movement velocity of the cursor, and controls a function for moving an object list displayed on the screen of the TV 110 according to a movement direction and acceleration of the cursor and displaying the moved object list. Also, the TV 110 selects a corresponding object according to a selection signal received from the portable terminal 100, moves the selected object according to motion information received from the portable terminal 100, and performs a function corresponding to the movement of the object.

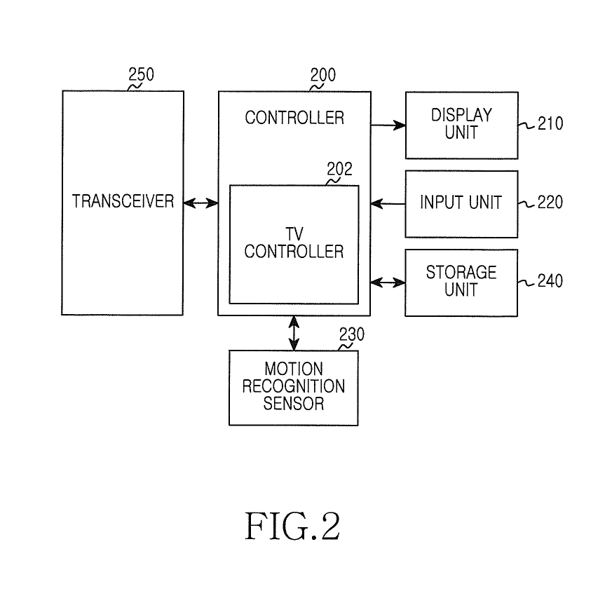

FIG. 2 illustrates a construction of a portable terminal according to an exemplary embodiment of the present disclosure.

Referring to FIG. 2, the portable terminal includes a controller 200, a display unit 210, an input unit 220, a motion recognition sensor 230, a storage unit 240, and a transceiver 250.

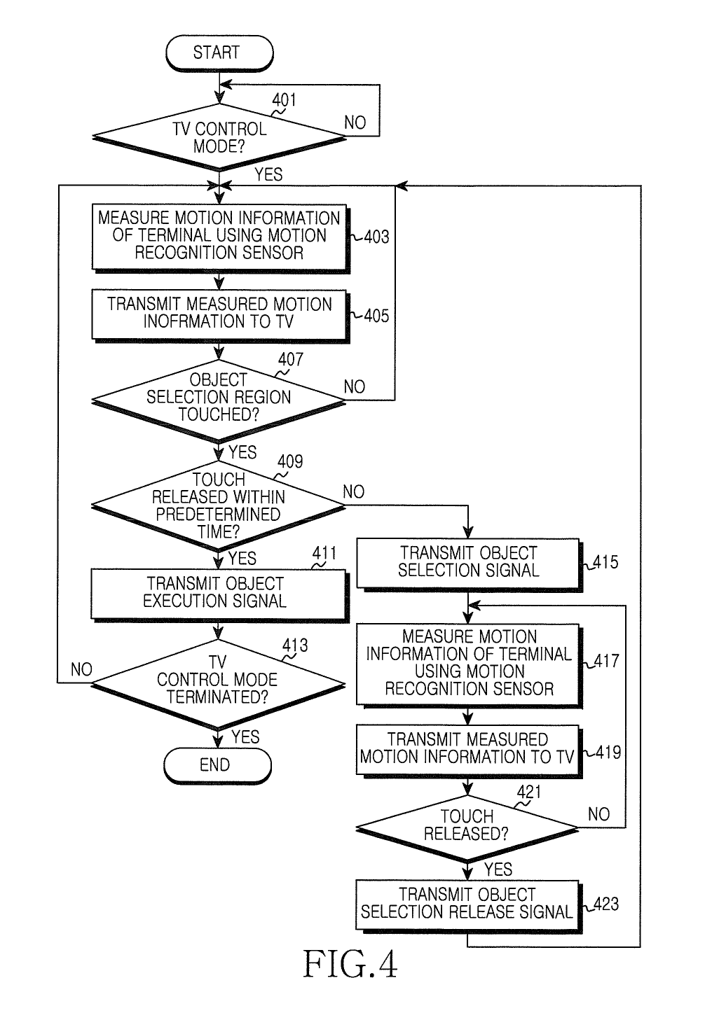

The controller 200 controls and processes a general operation of the portable terminal. By including a TV controller 202 according to the present disclosure, the controller 200 controls and processes a function for transmitting a control signal to a TV and controlling a cursor and object displayed on a screen of the TV, and various functions during a TV control mode. In detail, the TV controller 202 controls a function for transmitting motion information measured through the motion recognition sensor 230 to the TV during the TV control mode. Also, the TV controller 202 senses a screen touch by a user and transmits a signal requesting for object selection or object execution to the TV during the TV control mode. At this time, the TV controller 202 controls and processes a function for, when the screen touch is released within a predetermined time, transmitting a signal requesting for object execution to the TV and, when the screen touch is not released within the predetermined time, transmitting a signal requesting for object selection to the TV, and transmitting a signal requesting for object selection release to the TV at a time the screen touch is released. That is, the controller 200 controls and processes a function for performing an operation of FIG. 4 described below.

The display unit 210 displays various state information generated during an operation of the portable terminal, characters, numerals, and moving pictures. According to the present disclosure, the display unit 210 can display a screen representing that the display unit 210 is operating in the TV control mode during the TV control mode. At this time, the display unit 210 can display a selection button for selection of an object of a TV at a predetermined region of the screen.

The input unit 220 includes at least one function key and provides data corresponding to a key pressed by a user to the controller 200. Also, the input unit 220 includes a touch sensor, and senses a touch by the user and provides coordinate data of a position where the touch is sensed to the controller 200.

The motion recognition sensor 230 includes at least one sensor for recognizing a motion of the portable terminal dependent on user control. The motion recognition sensor 230 is driven according to control of the controller 200, and senses a direction of the terminal by a user's motion, an angle (or slope), an acceleration change and the like and provides them to the controller 200. For example, the motion recognition sensor 230 includes at least one of an acceleration sensor and a gyroscope sensor. Here, the acceleration sensor measures an acceleration generated due to a motion or movement of the portable terminal in a 3-Dimensional (3D) space, by sensing a change of gravity. At this time, the acceleration can be used for controlling a movement of a cursor of the portable terminal according to the present disclosure. Also, the gyroscope sensor measures the degree of rotation about a 3D rotation axis using properties that a thing is to stop and hold at the 3D rotation axis. At this time, X and Y-axe coordinates excepting, a Z-axis coordinate among 3D coordinates of X, Y, and Z axes measured in the gyroscope sensor can be changed into X and Y-axe coordinates for a screen of the TV.

The storage unit 240 stores various programs and data necessary for an operation of the portable terminal.

The transceiver 250 transmits a control signal to a TV according to control of the controller 200. That is, the transceiver 250 transmits a signal that represents motion information corresponding to a motion of the portable terminal and an object selection or object execution signal dependent on a user's touch, to the TV.

The method described above in relation with FIG. 2 under of the present invention may be provided as one or more instructions in one or more software modules stored in the respective portable terminals.

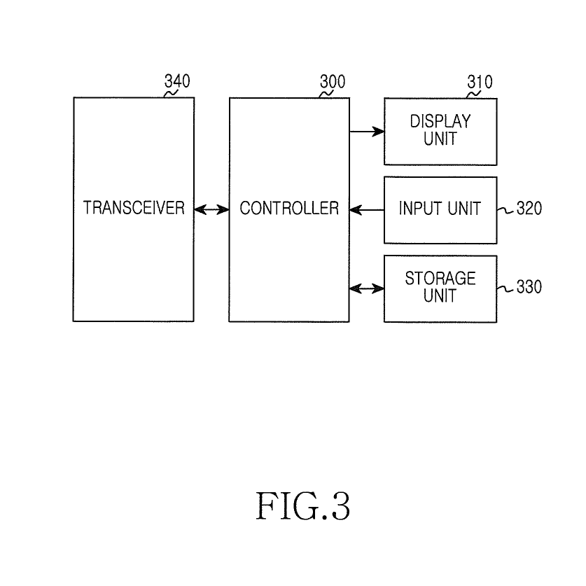

FIG. 3 illustrates a construction of a TV according to an exemplary embodiment of the present disclosure.

Referring to FIG. 3, the TV includes a controller 300, a display unit 310, an input unit 320, a storage unit 330, and a transceiver 340.

The controller 300 performs control and processing for a general operation of the TV, controls a cursor and object displayed on a screen of the TV according to a control signal received from a portable terminal, and controls and processes a function for performing various functions. Here, the object means various items displayed on the screen of the TV. For example, the object means an icon representing contents such as music, a video, a moving picture and the like, a menu icon for a specific function, a character input icon constructing a keypad and the like.

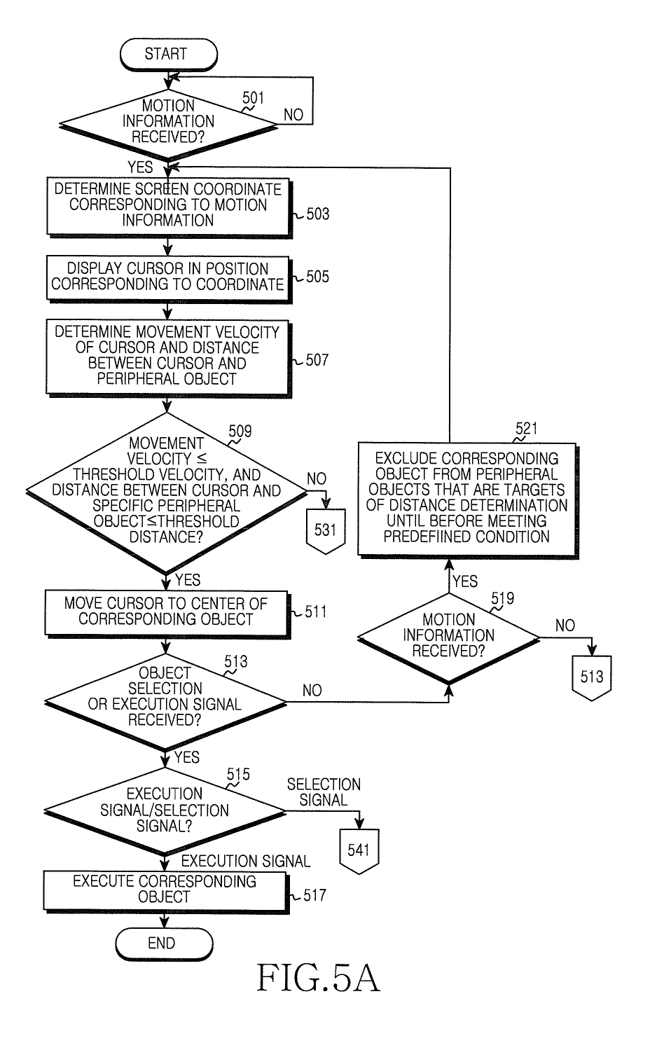

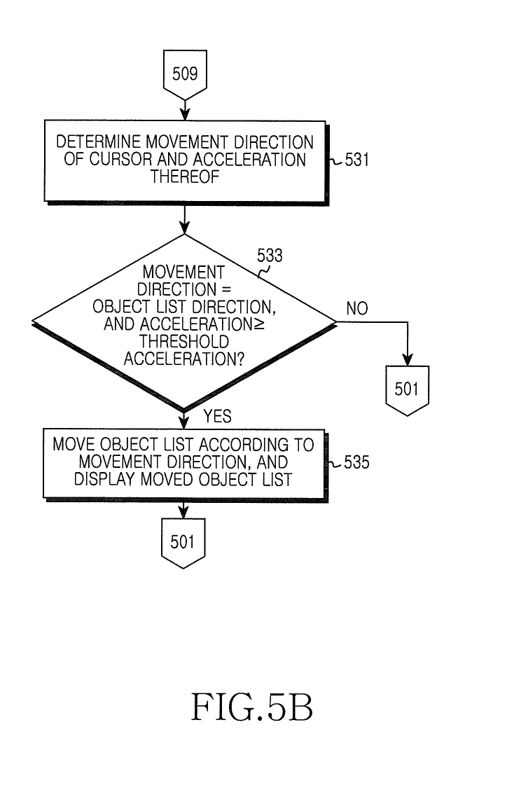

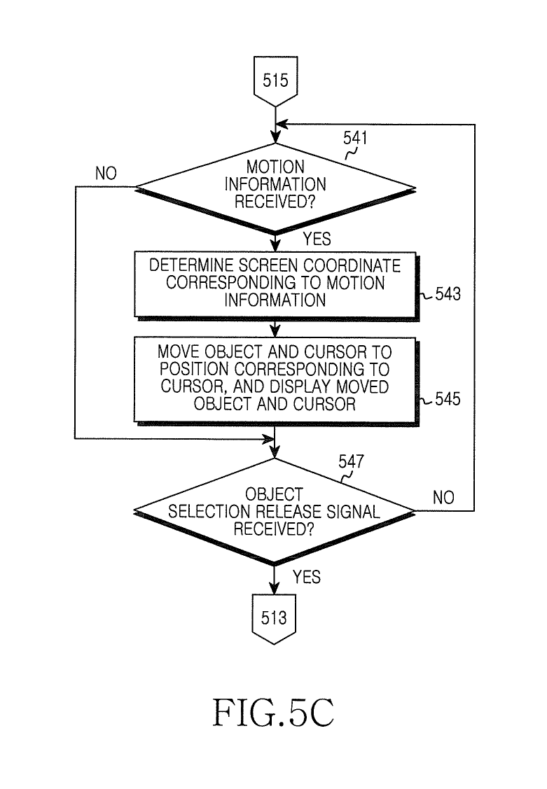

That is, the controller 300 receives motion information from the portable terminal, and controls a movement of a cursor and a movement of an object. Here, the cursor means an icon representing a user input position changing according to user control in a screen of the TV. In detail, the controller 300 controls and processes a function for analyzing motion information received from a portable terminal, determining a coordinate of the screen corresponding to the motion information, moving the cursor to the determined coordinate, and displaying the moved cursor. Also, the controller 300 controls and processes a function for analyzing the motion information and, on the basis of a distance between the cursor and a specific object displayed on the screen and a movement velocity of the cursor dependent on the motion information, moving the cursor to the center of the specific object, and displaying the moved cursor. Also, the controller 300 controls and processes a function for moving an object list on the basis of a movement direction and acceleration of the cursor dependent on the motion information and displaying the moved object list. Also, the controller 300 controls and processes a function for, when an execution signal from the portable terminal is received, executing an object corresponding, to a position of the cursor or executing a function corresponding to the object. Also, when a selection signal from the portable terminal is received, the controller 300 selects the object corresponding to the position of the cursor, receives motion information from the portable terminal, moves the selected object according to the received motion information, and displays the moved object. At this time, when there is a function corresponding to the movement of the object, the controller 300 performs the function. That is, the controller 300 controls and processes a function for performing an operation of FIGS. 5A to 5C described below.

The display unit 310 displays various state information generated during an operation of the TV, characters, numerals, and videos. Particularly, the display unit 310 displays a cursor and an object on the screen according to control of the controller 300.

The input unit 320 includes at least one function key and provides data corresponding to a key pressed by a user to the controller 300. Also, the input unit 320 can include a touch sensor, and sense a touch by the user and provide coordinate data of a position where the touch is sensed, to the controller 300. Also, the input unit 320 receives an input of user data from other external input devices and provides the user data to the controller 300.

The storage unit 330 stores various programs and data necessary for an operation of the TV. Particularly, the storage unit 330 stores various objects to be displayed on the screen according to the present disclosure.

The transceiver 340 receives a control signal from a portable terminal according to control of the controller 300. That is, the transceiver 340 receives a signal that represents motion information corresponding to a motion of the portable terminal and an object selection and object execution signal dependent on a user's touch from the portable terminal, and provides the signals to the controller 300.

The method described above in relation with FIG. 3 under of the present invention may be provided as one or more instructions in one or more software modules stored in the respective TV.

FIG. 4 illustrates a process of a portable terminal according to an exemplary embodiment of the present disclosure.

Referring to FIG. 4, in step 401, the portable terminal checks if the portable terminal enters a TV control mode. Here, the portable terminal can enter the TV control mode according to a user control or when a preset mode initiation condition is met.

If it is checked in step 401 that the portable terminal enters the TV control mode, in step 403, the portable terminal measures motion information (e.g., movement direction, movement velocity, angle, and acceleration) of the portable terminal using a motion recognition sensor and proceeds to step 405 and transmits the measured motion information to a TV.

After that, in step 407, the portable terminal checks if an object selection region displayed on a screen is touched by a user. If it is checked in step 407 that the object selection region is not touched, the portable terminal continues to perform a process of measuring motion information of the portable terminal in step 403 and then transmitting the measured motion information to the TV in step 405.

In contrast, if it is checked in step 407 that the object selection region is touched, in step 409, the portable terminal checks if the touch on the object selection region is released within a preset time. If it is checked in step 409 that the touch on the selection region is released within the preset time, in step 411, the portable terminal transmits a signal requesting for object execution to the TV, and proceeds to step 413 and checks if the TV control mode is terminated. Here, the portable terminal can terminate the TV control mode according to a user control or when a preset mode termination condition is met. For example, the portable terminal may terminate the TV control mode when no input associated with TV control is sensed during a preset waiting time. If it is checked in step 413 that the TV control mode is not terminated, the portable terminal returns to step 403. In contrast, if it is checked in step 413 that the TV control mode is terminated, the portable terminal terminates an algorithm according to the present disclosure.

On the other hand, if it is checked in step 409 that the touch on the object selection region is not released within the preset time, the portable terminal proceeds to step 415 and transmits a signal requesting for object selection to the TV. After that, in step 417, the portable terminal measures motion information (e.g., movement direction, movement velocity, angle, and acceleration) of the portable terminal using the motion recognition sensor, and proceeds to step 419 and transmits the measured motion information to the TV.

After that, in step 421, the portable terminal checks if the touch on the object selection region is released. If it is checked in step 421 that the touch on the object selection region is not released, the portable terminal continues to perform a process of measuring motion information of the portable terminal in step 417 and then transmitting the measured motion information to the TV in step 419. In contrast, if it is checked in step 421 that the touch on the object selection region is released, the portable terminal proceeds to step 423 and transmits a signal requesting for object selection release to the TV. Next, the portable terminal returns to step 403 and again performs the subsequent steps.

FIGS. 5A to 5C illustrate a process of a TV according to an exemplary embodiment of the present disclosure.

Referring to FIGS. 5A to 5C, in step 501, the TV checks if a control signal including motion information is received from a portable terminal. If it is checked in step 501 that the control signal including the motion information is received from the portable terminal, the portable terminal proceeds to step 503 and determines a coordinate of a screen corresponding to the motion information, and proceeds to step 505 and displays a cursor in a position of the screen corresponding to the determined coordinate.

After that, in step 507, the TV determines a movement velocity of the cursor and a distance between the cursor and a peripheral object. Then, the TV proceeds to step 509 and checks if the movement velocity is less than or equal to a threshold velocity, and the distance between the cursor and the specific object is less than or equal to a threshold distance. Here, the TV can measure a movement distance of the cursor in the screen of the TV every screen update period and determine the movement velocity of the cursor. Also, at a time the TV determines the distance between the cursor and the cursor peripheral object around the cursor, the TV determines a distance from a central point of the specific object to the cursor. If the movement velocity exceeds the threshold velocity or the distance between the cursor and the specific object exceeds the threshold distance, the TV proceeds to step 531 below.

In contrast, if it is checked in step 509 that the movement velocity is less than or equal to the threshold velocity and the distance between the cursor and the specific object is less than or equal to the threshold distance, in step 511, the TV activates a magnetic cursor function and moves the cursor to the center (or central point) of the specific object. At this time, the magnetic cursor function means a function of moving the cursor to the center of the specific object irrespective of the motion information received from the portable terminal. At a time the magnetic cursor function is activated, the TV applies an acceleration and moves the cursor to the center of the specific object at an accelerated velocity, thereby being capable of giving an effect as if the cursor goes dragged fast to the center the specific object. At this time, the TV can change a color of the cursor, a size, a shape and the like during the activation of the magnetic cursor function. Here, the magnetic cursor function is inactivated at the same time when the cursor moves to the center of the object.

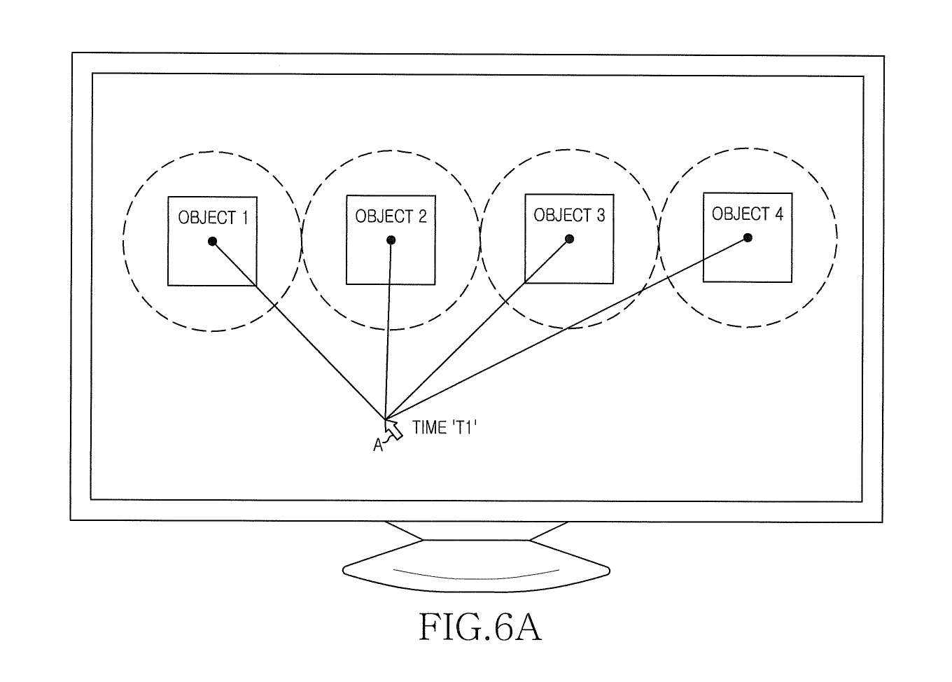

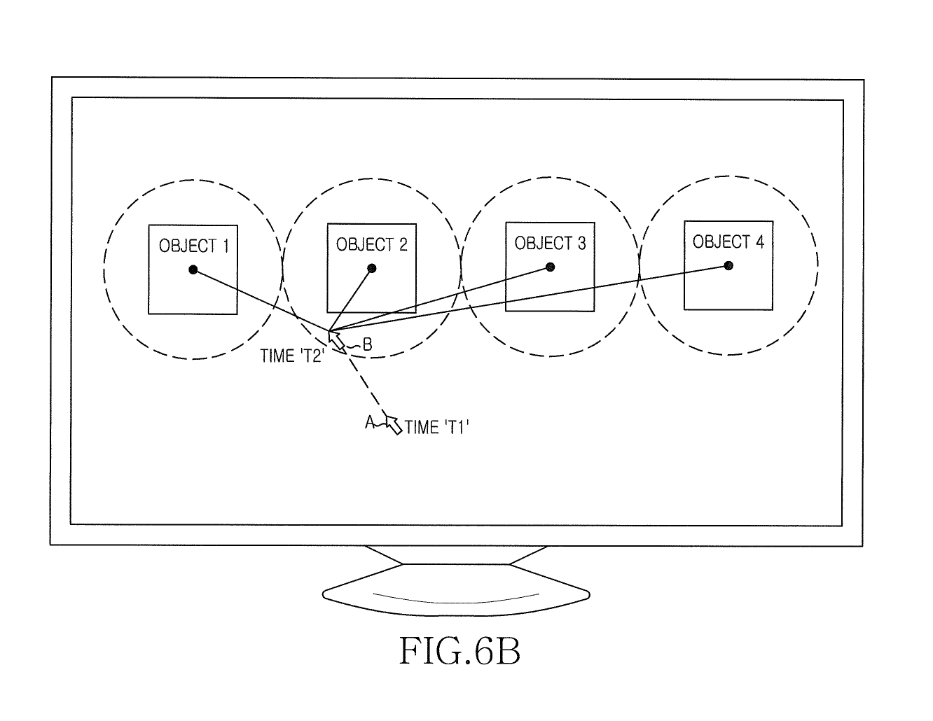

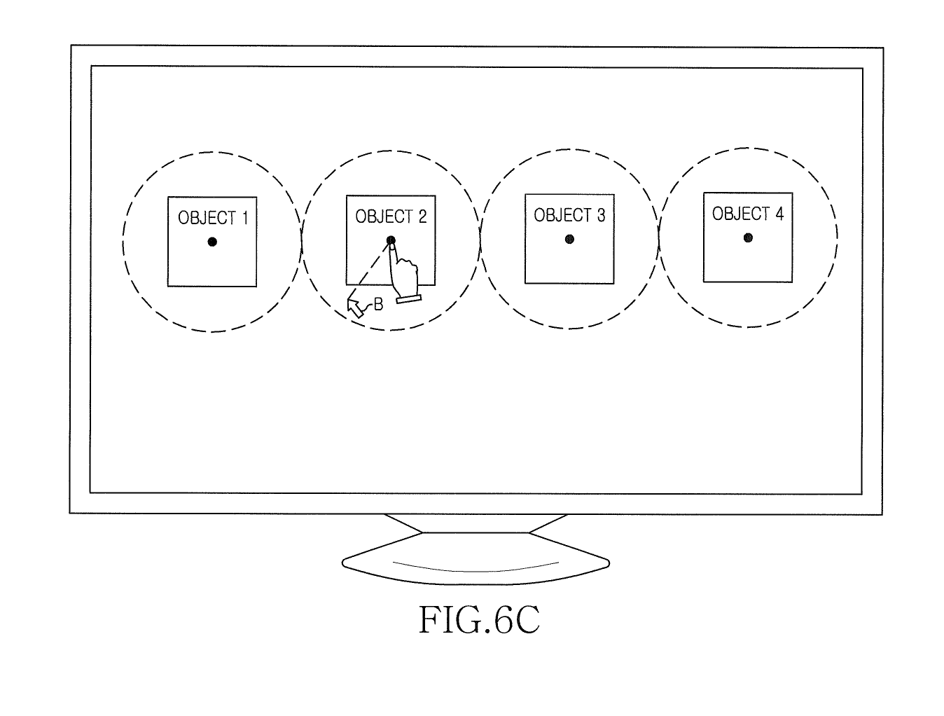

For instance, as illustrated in FIG. 6A, assuming that a cursor is positioned in a point ‘A’ at a time ‘t1’ in a state where a plurality of objects are displayed on a screen of the TV, the TV performs an operation of recognizing that the point ‘A’ where the cursor is positioned is a position where the cursor is spaced apart a threshold distance or more from each of the plurality of objects, determining a coordinate according to motion information received from a portable terminal, and moving a cursor according to the determined coordinate and displaying the moved cursor. After that, as illustrated in FIG. 6B, when the cursor is positioned in a point ‘B’ at a time ‘t2’, the TV recognizes that the point ‘B’ where the cursor is positioned is a position within the threshold distance from an object 2, measures a distance that the cursor has moved from the time ‘t1’ to the time ‘t2’, and determines a current movement velocity (i.e., movement distance/(t2−t1)). If the movement velocity is less than or equal to a threshold velocity, the TV activates the magnetic cursor function and, as illustrated in FIG. 6C, changes a shape of the cursor positioned in the point ‘B’ into a hand shape and then moves the cursor to a central position of the object 2 at an accelerated velocity. In contrast, although the cursor is positioned within the threshold distance from the object 2 at the time ‘t2’, when the current movement velocity (i.e., movement distance/(t2−t1)) exceeds the threshold velocity, the TV does not activate the magnetic cursor function and does perform a function of determining a coordinate according to motion information received from a portable terminal and moving the cursor to the determined coordinate.

In a state where the cursor is positioned in the center of the specific object in step 511, the TV proceeds to step 513 and checks if an object selection or object execution signal is received from the portable terminal. If it is checked in step 513 that the object selection or object execution signal is not received from the portable terminal, the TV proceeds to step 519 and checks if the motion information is received from the portable terminal. If it is checked in step 519 that the motion information is not received from the portable terminal, the TV returns to step 513. In contrast, if it is checked in step 519 that the motion information is received from the portable terminal, in step 521, the TV excludes the specific object in which the cursor is positioned, from peripheral objects that are targets of distance determination with the cursor, until before meeting a preset reselection condition and then, returns to step 503. This is for, when the TV has activated the magnetic cursor function and has moved the cursor to the center of the specific object but a user does not desire the selection or execution of the specific object and moves the cursor to another object through the portable terminal in order to select or execute the another object, preventing the cursor from again moving to the center of the specific object because the magnetic cursor activation condition of step 509 is met during the movement of the cursor. Here, the preset reselection condition can be set as various conditions according to a design scheme. For example, the preset reselection condition can be set as a specific time or a distance between the cursor and the specific object, and the movement of the cursor to the center of another object.

In contrast, if it is checked in step 513 that the object selection or object execution signal is received in the state where the cursor is positioned in the center of the specific object, the TV proceeds to step 515 and judges if the received signal is an object selection signal or is an object execution signal. At this time, if it is checked in step 515 that the received signal is the object execution signal, the TV executes the specific object where the cursor is positioned, and terminates an algorithm according to the present disclosure.

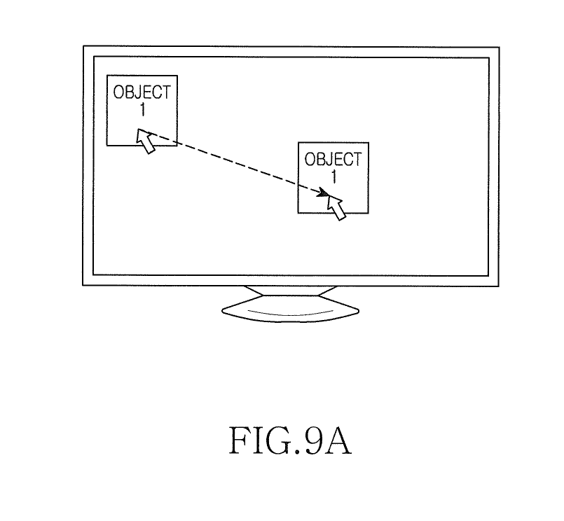

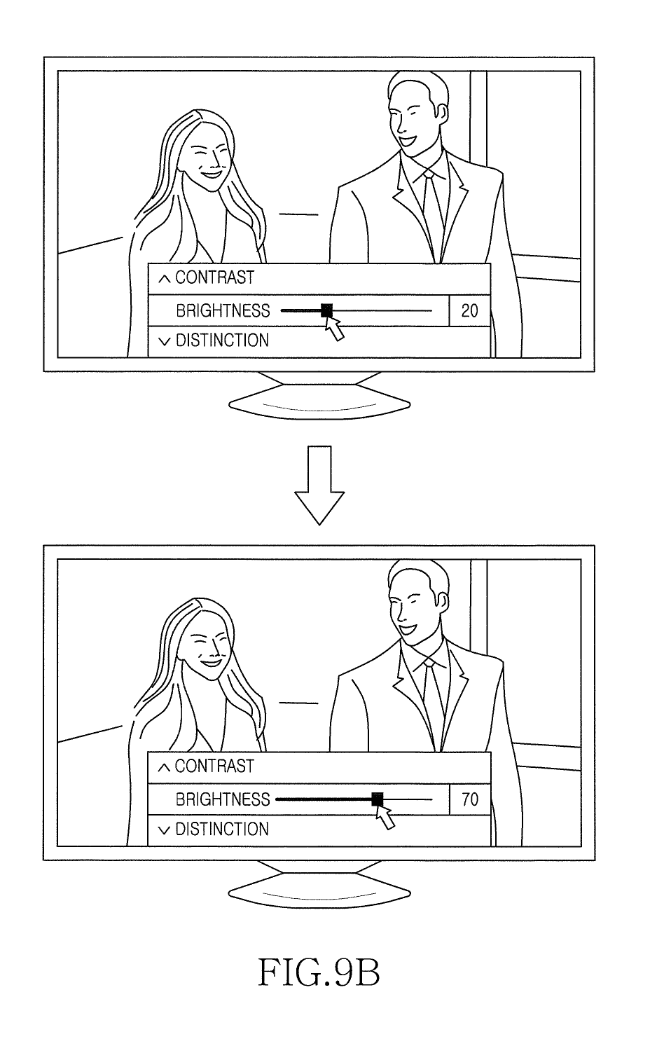

In contrast, if it is checked in step 515 that the received signal is the object selection signal, the TV proceeds to step 541 and checks if motion information is received from the portable terminal. If it is checked in step 541 that the motion information is not received from the portable terminal, the portable terminal proceeds to step 547 below. If it is checked in step 541 that the motion information is received from the portable terminal, the portable terminal proceeds to step 543 and determines a screen coordinate corresponding to the motion information. Then, in step 545, the portable terminal moves the specific object in which the cursor is positioned and the cursor to a position corresponding to the determined coordinate and displays the moved specific object and cursor. Here, a description has been, for example, made for example embodiment where a magnetic cursor function is activated and, after a cursor is moved to the center of a specific object, the cursor selects and moves the specific object in the TV, but it is natural that, in a state where the magnetic cursor function is not activated, even when a cursor is moved to a region of a specific object according to motion information of a portable terminal, the cursor can select and move the specific object. For example, as illustrated in FIG. 9A, in a state where a cursor is positioned in a region of an object 1, if object selection information is received from a portable terminal, the TV selects the object 1 and then, the TV simultaneously moves the cursor and the object according to motion information received from the portable terminal and displays the moved cursor and object.

Here, when a function (i.e., brightness adjustment, contrast adjustment, distinction adjustment, volume adjustment, or screen scroll function) corresponding to a movement of the specific object is set, the TV performs the corresponding function. For instance, as illustrated in FIG. 9B, in a state where a cursor is positioned in an object adjusting brightness in the TV, if object selection information is received from a portable terminal and motion information representing a movement to the right direction is received from the portable terminal, the TV moves the cursor and the object to the right while simultaneously, adjusting a screen brightness of the TV depending on a movement distance of the cursor.

After that, in step 547, the TV checks if an object selection release signal is received from the portable terminal. If it is checked in step 547 that the object selection release signal is received from the portable terminal, the TV returns to step 513 and, if it checked in step 547 that the object selection release signal is not received from the portable terminal, the TV returns to step 541 and again performs the subsequent steps.

In contrast, if it is checked in step 509 that the movement velocity exceeds the threshold velocity or the distance between the cursor and the specific object exceeds the threshold distance, the TV proceeds to step 531 and determines a movement direction of the cursor and an acceleration of the cursor. After that, in step 533, the TV checks if the movement direction of the cursor is equal to an object list direction and the acceleration is greater than or equal to a threshold acceleration. Here, the object list direction is a direction in which an object list is displayed in the TV. Generally, the object list can be displayed in any one of a horizontal direction and a vertical direction. The TV can measure a movement distance of a cursor and a movement direction thereof on the basis of a screen update period and, through this, determine an acceleration of the cursor. At this time, if it is checked in step 533 that the movement direction of the cursor is not equal to the object list direction or the acceleration is less than the threshold acceleration, the TV returns to step 501 and again performs the subsequent steps.

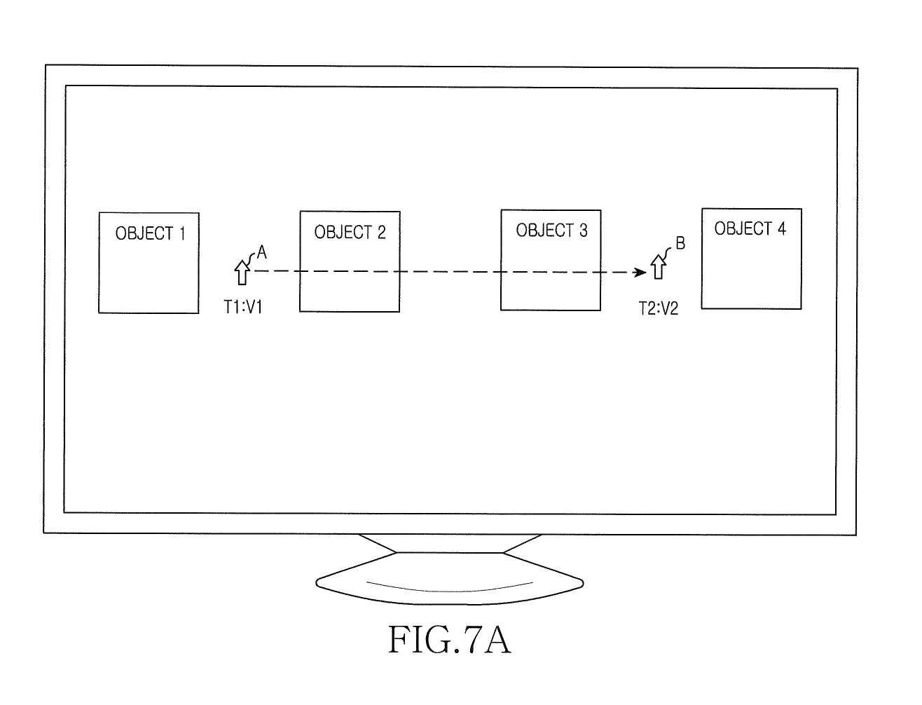

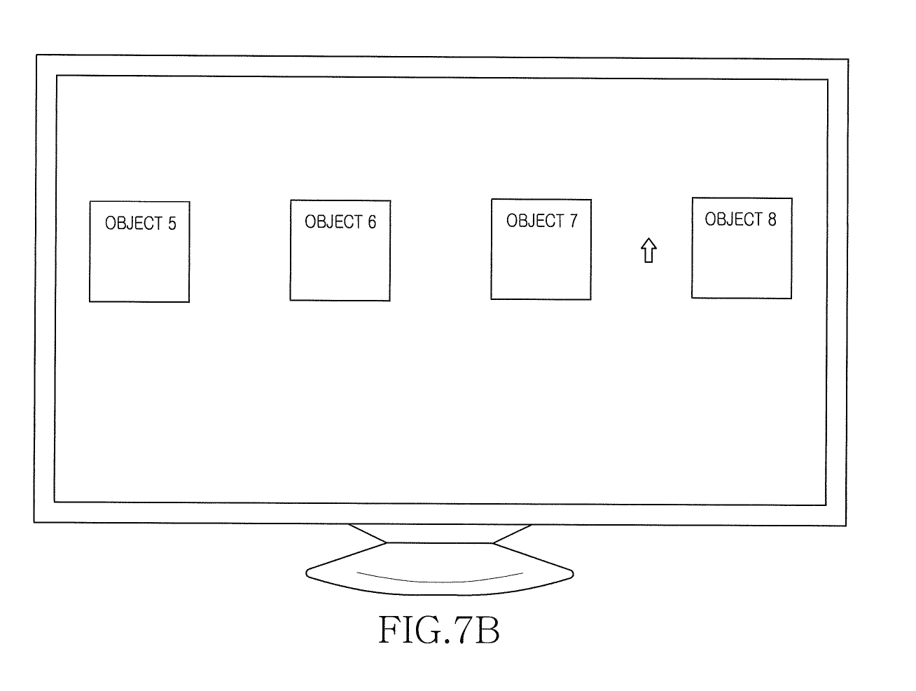

In contrast, if it is checked in step 533 that the movement direction of the cursor is equal to the object list direction and the acceleration is greater than or equal to the threshold acceleration, the TV proceeds to step 535 and moves the corresponding object list according to the movement direction of the cursor and displays the moved object list and then, returns to step 501. For example, as illustrated in FIG. 7A, in a state where an object 1 to an object 4 are displayed, when a cursor positioned in a point ‘A’ at a time ‘t1’ moves to a point ‘B’ at a time ‘t2’, the TV recognizes that a movement direction of the cursor is equal to an object list direction, and measures an acceleration (|(v2−v1)/(t2−t1)|) of the cursor using a velocity ‘v1’ of the time ‘t1’ and a velocity ‘v2’ of the time ‘t2’. At this time, when the acceleration of the cursor is greater than or equal to the threshold acceleration, as illustrated in FIG. 7B, the TV can move an object list and display an object 5 to an object 8 on a screen of the TV. At this time, when the condition of step 533 is met, the TV can move objects in a preset group unit and display the moved objects, and can display the objects as movement ranges of the objects are varied depending on the acceleration of the cursor. For example, in a state an object 1 to an object 4 are displayed on a screen of the TV, when an acceleration of the cursor is equal to ‘a’, the TV can move an object list and display an object 3 to an object 6 on the screen of the TV. When the acceleration of the cursor is equal to ‘b’ and the ‘b’ is greater than the ‘a’, the TV can move the object list much more and display an object 7 to an object 10 on the screen of the TV.

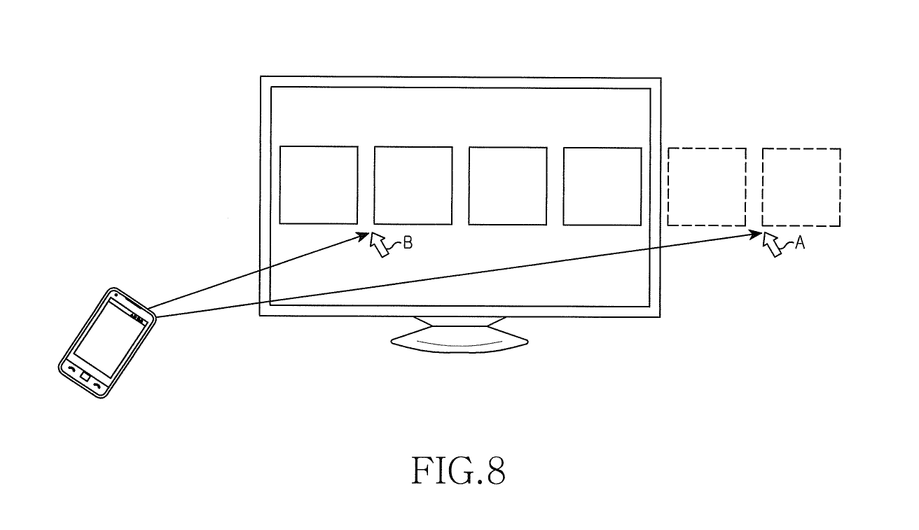

In addition, in a state where the condition of step 533 is met, when a position represented by motion information received from the portable terminal is a region outside the screen of the TV, the TV may obtain a physical coordinate of the region outside the screen of the TV, confirm an object corresponding to the physical coordinate, and move an object list such that the confirmed object is displayed on the screen of the TV. For example, as illustrated in FIG. 8, when a cursor of a TV is moved from a point ‘B’ to a point ‘A’ outside a screen of the TV according to motion information of a portable terminal, the TV may move an object list such that an object corresponding to the point ‘A’ in the object list is displayed on the screen of the TV.

The aforementioned description has been made for a scheme in which the portable terminal transmits motion information measured through a motion recognition sensor to the TV and controls a cursor of the TV. However, according to another exemplary embodiment of the present disclosure, the portable terminal can transmit coordinate information of its screen sensed through a touch sensor to the TV and control a cursor of the TV. For instance, when a user touches the screen of the portable terminal in a forms of a closed curve, the portable terminal can sense screen coordinates corresponding to the closed curve in real-time and transmit the sensed screen coordinates to the TV, and the TV can convert the received screen coordinates of the portable terminal into coordinates of a screen of the TV and move the cursor according to the converted coordinates in the closed curve form.

Also, according to a further another exemplary embodiment of the present disclosure, the portable terminal can transmit information representing a function corresponding to a button selected by a user to the TV, and control a cursor of the TV. For example, in a situation in which a portable terminal has direction buttons representing up/down/left/right movement, when a user selects the down button, the portable terminal can transmit information requesting for down movement to the TV and, in response to the down movement request of the portable terminal, the TV can move a cursor in a down direction. At this time, the portable terminal may control a movement distance of the cursor and a movement velocity thereof depending on a time during which the user selects and holds a corresponding button. Here, the buttons of the portable terminal can be physical key buttons or touch buttons displayed on the screen of the portable terminal.

In the present disclosure, a description has been made for a magnetic cursor function of moving a cursor to the center of an object according to motion information of a portable terminal, a function of moving an object list according to motion information of the portable terminal, and a function of moving an object according to selection of the portable terminal and motion information of the portable terminal. Here, the magnetic cursor function is effectively applicable when selecting a specific item, icon or program from a menu in an electronic device, when selecting a hyperlink icon, menu, text and photo in a web browsing screen, when selecting a character key from a keypad displayed on a screen and inputting a character, and when selecting a specific object within contents. Also, the function of moving the object list is effectively applicable when a user intends to find out a desired contents item in a state where a contents list such as a photo, a moving picture and the like is displayed in an electronic device. Also, the function of moving the object is effectively applicable to a configuration such as brightness adjustment, contrast adjustment, distinction adjustment, volume adjustment and the like in an electronic device, and is effectively applicable to a function such as scroll function, puzzle game, screen edit and the like.

In the present disclosure, there is an effect that a control device senses motion information and transmits the motion information to an electronic device, and the electronic device performs controlling of a cursor of a screen, an object list displayed on the screen, movement of an object, and execution of a function corresponding to the movement of the object dependent on the motion information of the control device, thereby enabling all users inclusive of infants, the old, and the disabled to easily use various functions of the electronic device and improving the use of the electronic device.

Methods according to exemplary embodiments disclosed in claims and/or the specification of the present disclosure can be implemented in hardware, software, or a form of combination thereof.

In embodiments of the present disclosure implemented in software, a computer readable storage medium storing one or more programs (i.e., software modules) can be provided. One or more programs stored in the computer readable storage medium are configured to be executable by one or more processors within an electronic device. One or more programs include instructions for enabling the electronic device to execute the methods according to the exemplary embodiments disclosed in the claims and/or the specification of the present disclosure.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a compact disk ROM (CD-ROM), a Digital Versatile Disk (DVD) or an optical storage device of other form, and a magnetic cassette. Or, they can be stored in a memory constructed in a combination of some or all of them. Also, each construction memory may be included in plural.

Further, the programs can be stored in a storage device attachable to an electronic device and accessible through a communication network such as the Internet, an intranet, a Local Area Network (LAN), a Wireless LAN (WLAN), or a Storage Area Network (SAN), or a communication network configured in a combination of them. This storage device can access the electronic device through an external port.

Furthermore, a separate storage device on a communication network may access a portable electronic device.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of controlling an electronic device using a control device, the method comprising:
moving a cursor displayed on a screen of the electronic device according to cursor control information received from the control device;
measuring a distance between a position of the cursor and a peripheral object; and
when the measured distance is less than or equal to a threshold distance, moving the cursor to a position corresponding to the peripheral object.

2. The method of claim 1 further comprising:
when the measured distance is less than or equal to the threshold distance, measuring a movement velocity of the cursor,
wherein, when the movement velocity is less than or equal to a threshold velocity, the cursor is moved to the position corresponding to the peripheral object.

3. The method of claim 1, wherein moving the cursor to the position corresponding to the specific object comprises moving the cursor to the center of the peripheral object at an accelerated velocity.

4. The method of claim 1 further comprising:
when the measured distance is less than or equal to the threshold distance, activating a magnetic cursor function; and
after moving the cursor to the position corresponding to the peripheral object, deactivating the magnetic cursor function,
wherein, in a state where the magnetic cursor function is activated, the cursor is moved to the position corresponding to the peripheral object irrespective of the cursor control information received from the control device and, in a state where the magnetic cursor function is deactivated, the cursor is moved according to the cursor control information received from the control device.

5. The method of claim 4, wherein, in the state where the magnetic cursor function is activated, at least one of a color of the cursor, a size of the cursor, and a shape of the cursor is changed.

6. The method of claim 4, wherein, after deactivating the magnetic cursor function, the object to which the cursor is moved by the magnetic cursor function is excluded from a target of distance measurement with the cursor.

7. A method of controlling an electronic device using a control device, the method comprising:
moving a cursor displayed on a screen of the electronic device according to cursor control information received from the control device;
determining whether a movement direction of the cursor is similar to an object list direction; and
when the movement direction of the cursor is similar to the object list direction, moving an object list according to the movement direction of the cursor and displaying the moved object list.

8. The method of claim 7 further comprising:
when the movement direction of the cursor is similar to the object list direction, measuring an acceleration of the cursor,
wherein, when the acceleration of the cursor is greater than or equal to a threshold acceleration, moving the object list according to the movement direction of the cursor and displaying the moved object list.

9. The method of claim 7 further comprising identifying a movement range of the object list based on the acceleration of the cursor.

10. A method for controlling an electronic device in a control device, the method comprising:
generating cursor control information using at least one sensor;
transmitting the generated cursor control information to the electronic device; and
when a screen touch by a user is sensed, transmitting a signal representing at least one of screen touch, a touch and hold and a touch release to the electronic device.

11. An electronic device using a control device, the electronic device comprising:
a receiver configured to receive a signal from the control device;
a display unit configured to perform screen display; and
a controller configured to move a cursor displayed on a screen of the electronic device according to cursor control information received from the control device, measure a distance between a position of the cursor and a peripheral object, and, when the measured distance is less than or equal to a threshold distance, move the cursor to a position corresponding to the peripheral object.

12. The electronic device of claim 11, wherein, when the measured distance is less than or equal to the threshold distance, the controller is configured to measure a movement velocity of the cursor and, when the movement velocity is less than or equal to a threshold velocity, the controller is configured to move the cursor to the position corresponding to the peripheral object.

13. The electronic device of claim 11, wherein the controller is configured to move the cursor to the center of the peripheral object at an accelerated velocity.

14. The electronic device of claim 11, wherein:
when the measured distance is less than or equal to the threshold distance, the controller is configured to activate a magnetic cursor function and, after moving the cursor to the position corresponding to the peripheral object, deactivate the magnetic cursor function,
in a state where the magnetic cursor function is activated, the controller is configured to move the cursor to the position corresponding to the peripheral object irrespective of the cursor control information received from the control device, and
in a state where the magnetic cursor function is deactivated, the controller is configured to move the cursor according to the cursor control information received from the control device.

15. The electronic device of claim 14, wherein, in the state where the magnetic cursor function is activated, the display unit is configured to change at least one of a color of the cursor, a size of the cursor, and a shape of the cursor according to control of the controller.

16. The electronic device of claim 14, wherein, after deactivating the magnetic cursor function, the controller is configured to exclude the object to which the cursor is moved by the magnetic cursor function, from a target of distance measurement with the cursor.

17. An electronic device using a control device, the electronic device comprising:
a receiver configured to receive a signal from the control device;
a display unit configured to perform screen display; and
a controller configured to move a cursor displayed on a screen of the electronic device according to cursor control information received from the control device, determine whether a movement direction of the cursor is similar to an object list direction and, when the movement direction of the cursor is similar to the object list direction, move an object list according to the movement direction of the cursor and displaying the moved object list.

18. The electronic device of claim 17, wherein, when the movement direction of the cursor is similar to the object list direction, the controller is configured to measure an acceleration of the cursor and, when the acceleration of the cursor is greater than or equal to a threshold acceleration, the controller is configured to move the object list according to the movement direction of the cursor and display the moved object list.

19. The electronic device of claim 17, wherein the controller is configured to identify a movement range of the object list based on the acceleration of the cursor.

20. A control device configured to control an electronic device, the control device comprising:
a transmitter configured to transmit a signal to the electronic device;
at least one sensor configured to generate cursor control information about the electronic device;
a touch sensor configured to sense a screen touch by a user; and
a controller configured to control to transmit the created cursor control information to the electronic device and, when the screen touch by the user is sensed, transmit a signal representing at least one of a screen touch, a touch and hold and a touch release to the electronic device.
